(19) United States
(12) Patent Application Publication
(10) Pub. No.: US 2020/0043193 A1
(43) Pub. Date: Feb. 6, 2020

(54) POSITION DETERMINATION METHODS AND SYSTEMS FOR VEHICLE

(71) Applicant: Noodoe Corporation, Taipei City (TW)

(72) Inventors: Ying-Chieh Hu, Taipei City (TW); Chun-Hao Fu, Taipei City (TW); Yi-An Hou, Taipei City (TW); Chun-Hung Kung, Taipei City (TW)

(21) Appl. No.: 16/531,164

(22) Filed: Aug. 5, 2019

(30) Foreign Application Priority Data
Aug. 6, 2018 (TW) 107127187

(51) Int. Cl. G06T 7/70; G06K 9/20

(52) U.S. Cl. CPC G06T 7/70; G06K 9/2081; G06F 21/602; G06T 2207/30252; G06K 2209/15

(57) ABSTRACT

Position determination methods and systems for vehicle applied to an electronic device are provided. First, images of a vehicle are continuously captured by an image capture unit. Next, a selection of a marked position corresponding to the vehicle is received. First sensing data corresponding to the marked position is obtained via at least one sensor. A first image corresponding to the vehicle is captured and second sensing data is obtained via the at least one sensor. Then, an angle is calculated according to the marked position, the first sensing data, and the second sensing data, and a specific position of the vehicle corresponding to the first image is determined according to the marked position and the calculated angle.

### BACKGROUND OF THE INVENTION

### Field of the Invention

The disclosure relates generally to position determination methods and systems, and, more particularly to position determination methods and systems for determining vehicle-related positions.

### Description of the Related Art

Recently, with the development of image recognition technology, image recognition capabilities have become more and more technically advanced. Through some image recognition technologies, such as deep learning or feature classification and recognition, most of the images can be identified and various applications can be performed, such as recognizing facial images and managing access control based on the identification results. However, for some images with the same appearance characteristics, such as vehicle images, current image recognition technology still cannot provide accurate identification results, and thus correct positions of the images cannot be determined, so that the recognition accuracy is reduced, and the related applications cannot continue to develop. For example, as a vehicle such as a small car has four wheels of the same shape, when the vehicle image is a wheel image, the vehicle position for such image can only be recognized as it is the wheel position according to its appearance, but the position and direction of the wheel cannot be known. Therefore, it is impossible to determine whether the wheel image is the image of the left front wheel, the left rear wheel, the right front wheel, or the right rear wheel. In other words, it is impossible to know the exact vehicle position based on the image recognition result for those images.

Therefore, there is a need for a position determination method and system for vehicle, which can improve the recognition accuracy of the vehicle-related image and can determine the position of the vehicle represented by the specific image.

### BRIEF SUMMARY OF THE INVENTION

Position determination methods and systems for vehicles applied to an electronic device are provided, wherein the position of the vehicle for a particular image can be determined according to a marked position in the vehicle images captured by an image capture unit of the electronic device and sensing data of at least one sensor.

In an embodiment of a position determination method for vehicle applied to an electronic device, images of a vehicle are continuously captured by an image capture unit. Next, a selection of a marked position corresponding to the vehicle is received. First sensing data corresponding to the marked position is obtained via at least one sensor. A first image corresponding to the vehicle is captured and second sensing data is obtained via the at least one sensor. Then, an angle is calculated according to the marked position, the first sensing data, and the second sensing data, and a specific position of the vehicle corresponding to the first image is determined according to the marked position and the calculated angle.

An embodiment of a position determination system for vehicle for use in an electronic device comprises at least one sensor, an image capture unit and a processing unit. The at least one sensor is configured to detect a orientation of the electronic device to generate corresponding sensing data. The image capture unit is configured to continuously capture images of a vehicle. The processing unit is coupled to the at least one sensor and the image capture unit for receiving a selection of a marked position corresponding to the vehicle, obtaining first sensing data corresponding to the marked position via the at least one sensor, capturing a first image corresponding to the vehicle via the image capture unit and obtaining second sensing data via the at least one sensor, calculating an angle according to the marked position, the first sensing data, and the second sensing data, and determining a specific position of the vehicle corresponding to the first image according to the marked position and the calculated angle.

In some embodiments, a plurality of vehicle positions corresponding to the marked position are provided, wherein each of the vehicle positions has a mapping relation corresponding to one of a plurality of angular intervals, and one of the angular intervals is determined according to the determined angle, and one of the vehicle positions is determined as the specific position according to the determined angular interval.

In some embodiments, an image index corresponding to the marked position is provided and the image index corresponding to the marked position is displayed in a user interface for indicating the marked position via a display unit.

In some embodiments, a partial image corresponding to the selected marked position is obtained, an image recognition is performed on the partial image to obtain an identification image corresponding to the partial image, and one of the mapping relations is determined according to the identification image, and the specific position of the vehicle corresponding to the first image is determined according to the determined mapping relation and the determined angle, wherein each of the mapping relations includes a plurality of vehicle positions and a plurality of angular intervals and each of the vehicle positions corresponds to one of the angular intervals.

In some embodiments, data containing the determined angle is encrypted to generate an encrypted data using first data, a second image is generated according to the encrypted data and the first image, and the second image is stored to a storage unit or the second image is transmitted to a network server via a network. In some embodiments, the second image and the first data are obtained and the second image is decrypted with the first data to obtain the determined angle and the first image.

In some embodiments, the sensor comprises a compass, an accelerometer, and/or a Gyro sensor.

In some embodiments, the marked position is a license plate of the vehicle.

Position determination methods for vehicles may take the form of a program code embodied in a tangible media. When the program code is loaded into and executed by a machine, the machine becomes an apparatus for practicing the disclosed method.

Other aspects and features of the present invention will become apparent to those with ordinary skill in the art upon review of the following descriptions of specific embodiments of the mobile devices and electronic devices for carrying out the position determination methods for vehicles.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a position determination system for vehicle of the invention;

FIG. 2 is a schematic diagram illustrating another embodiment of a position determination system for vehicle of the invention;

FIG. 3 is a flowchart of an embodiment of a position determination method for vehicle of the invention;

FIG. 4 is a schematic diagram illustrating an example of the angle calculation of the invention; and

FIG. 5 is a flowchart of another embodiment of a position determination method for vehicle of the invention.

### DETAILED DESCRIPTION OF THE INVENTION

Position determination methods and systems for vehicles applied to an electronic device are provided

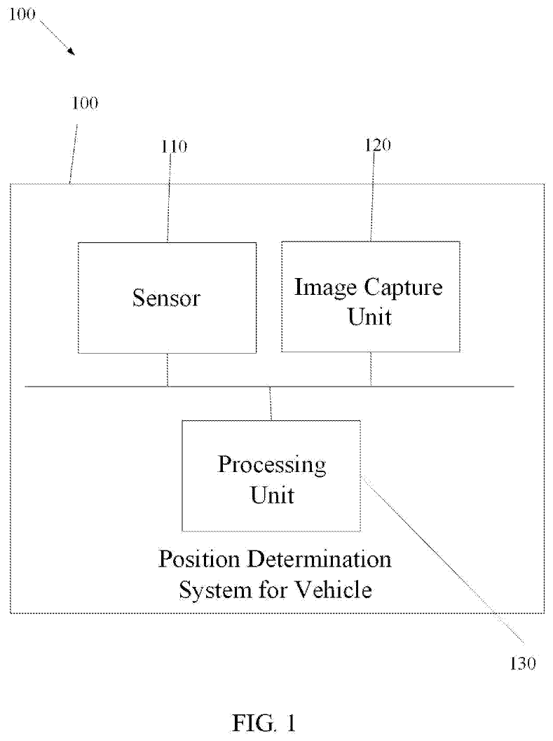

FIG. 1 is a schematic diagram illustrating an embodiment of a position determination system for vehicle of the invention. The position determination system for vehicle 100 of the invention can be used in an electronic device. In some embodiments, the electronic device may be a portable device, such as a camera, a mobile phone, a smart phone, a PDA (Personal Digital Assistant), a GPS (Global Positioning System), a notebook, a tablet computer, or a wearable device. The position determination system for vehicle 100 comprises at least one sensor 110, an image capture unit 120, and a processing unit 130. The sensor 110 can detect the orientation of an electronic device and generate corresponding sensing data. In some embodiments, the sensor 110 may be an accelerometer such as a G-sensor for generating information of velocity and displacement when the electronic device moves. In some embodiments, the sensor 110 may be a Gyro sensor for generating information of angular acceleration when the electronic device moves. In some embodiments, the sensor 110 may be a compass for detecting an angle between an electronic device and a geographical direction, such as direction of the North Pole or the South Pole. It is understood that, the above sensors are examples of the application, and the present invention is not limited thereto. Any sensor which can detect the orientation of an electronic device can be applied in the present invention. As described, the sensor 110 can detect the orientation of the electronic device. It is noted that, in some embodiments, the orientation comprises angle information corresponding to the electronic device in reference to at least one reference point. In some embodiments, the orientation can be represented as an included angle between an axis which is vertical to at least one plane of the electronic device and a specific direction, such as the direction of gravity or the geographical direction. In some embodiments, the six-axis coordinates of the electronic device may be tracked according to a combination of an azimuth angle and an elevation angle of the electronic device detected by the sensor (e.g., a Gyro sensor) and a technique of visual inertial ranging, wherein the six-axis coordinate data indicates the world coordinates and rotation and displacements around the X, Y, and Z axis, respectively. The three axes of displacement determine the orientation and size of the electronic device. In other words, the absolute world coordinates of the electronic device at this time can be obtained by the corresponding sensing data generated by the sensor 110. The image capture unit 120 may be a Charge Coupled Device (CCD) or a Complementary Metal-Oxide Semiconductor (CMOS), which is placed at an imaging position of a target object inside the device for image processing. The processing unit 130 can control related operations of hardware and software in the electronic device, and perform the position determination methods for vehicle of the invention, which will be discussed later. It is understood that, in some embodiments, the position determination system for vehicle 100 can further comprise a storage unit (not shown in FIG. 1). The storage unit can store related data, such as images captured by the image capture unit 120 and/or information generated by the processing unit 130. display unit (not shown in FIG. 1). It is understood that, in some embodiments, the position determination system for vehicle 100 can further comprise a display unit (not shown in FIG. 1) for displaying related information, such as images, interfaces, and/or related data.

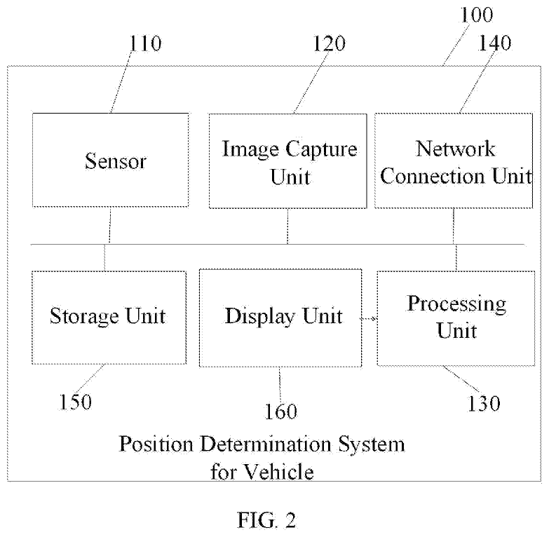

FIG. 2 is a schematic diagram illustrating another embodiment of a position determination system for vehicle of the invention. The position determination system for vehicle 100 of the invention can be used in an electronic device. In some embodiments, the electronic device may be a portable device, such as a camera, a mobile phone, a smart phone, a PDA (Personal Digital Assistant), a GPS (Global Positioning System), a notebook, a tablet computer, or a wearable device. The position determination system for vehicle 100 comprises at least one sensor 110, an image capture unit 120, a network connection unit 140, a storage unit 150, a display unit 160 and a processing unit 130. The sensor 110 can detect the orientation of an electronic device and generate corresponding sensing data. In some embodiments, the sensor 110 may be an accelerometer such as a G-sensor for generating information of velocity and displacement when the electronic device moves. In some embodiments, the sensor 110 may be a Gyro sensor for generating information of angular acceleration when the electronic device moves. In some embodiments, the sensor 110 may be a compass for detecting an angle between an electronic device and a geographical direction, such as direction of the North Pole or the South Pole. It is understood that, the above sensors are examples of the application, and the present invention is not limited thereto. Any sensor which can detect the orientation of an electronic device can be applied in the present invention. As described, the sensor 110 can detect the orientation of the electronic device. It is noted that, in some embodiments, the orientation comprises angle information corresponding to the electronic device in reference to at least one reference point. In some embodiments, the orientation can be represented as an included angle between an axis which is vertical to at least one plane of the electronic device and a specific direction, such as the direction of gravity or the geographical direction. In some embodiments, the six-axis coordinates of the electronic device may be tracked according to a combination of an azimuth angle and an elevation angle of the electronic device detected by the sensor (e.g., a Gyro sensor) and a technique of visual inertial ranging, wherein the six-axis coordinate data indicates the world coordinates and rotation and displacements around the X, Y, and Z axis, respectively. The three axes of displacement determine the orientation and size of the electronic device. In other words, the absolute world coordinates of the electronic device at this time can be obtained by the corresponding sensing data generated by the sensor 110. The image capture unit 120 may be a Charge Coupled Device (CCD) or a Complementary Metal-Oxide Semiconductor (CMOS), which is placed at an imaging position of a target object inside the device for image processing. The network connection unit 140 can connect to a network, such as a wired network, a telecommunication network, and/or a wireless network such as Bluetooth or Wi-Fi network. The position determination system for vehicle 100 can have network connectivity capabilities by using the network connection unit 140. The storage unit 150 can store related data, such as images captured by the image capture unit 120 and/or information generated by the processing unit 130. The display unit 160 can display related information, such as images, interfaces, and/or related data. The processing unit 130 can control related operations of hardware and software in the electronic device, and perform the position determination methods for vehicle of the invention, which will be discussed later.

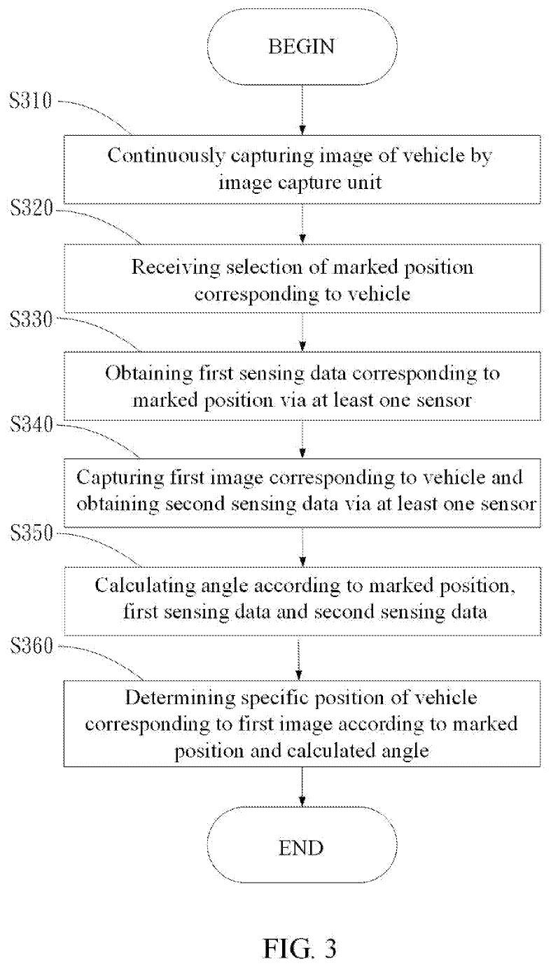

FIG. 3 is a flowchart of an embodiment of a position determination method for vehicle of the invention. The position determination method for vehicle of the invention can be used in an electronic device, such as a mobile phone, a smart phone, a PDA, a GPS, a notebook, a tablet computer, a wearable device, or other portable devices.

First, in step S310, images of a vehicle are continuously captured by an image capture unit. An image of the vehicle may be an image of a part or all of a vehicle such as a car. The user of the electronic device can turn on the image capturing function to continuously capture any part of the vehicle through the image capture unit to generate the images of the vehicle. For example, the image of the vehicle may include a partial image including a designated marked position or a partial image of the vehicle such as an image containing the wheel part of the vehicle. It is understood that, the above images of the vehicle are examples of the application, and the present invention is not limited thereto. In an embodiment, the marked position can be set as the license plate position of the vehicle. In another embodiment, a plurality of marked points may be provided and the user may select one of the aforementioned marked points to determine the marked position. It is noted that, in some embodiments, an image index corresponding to the marked position may be provided when capturing an image of the vehicle, and the image index corresponding to the marked position can be displayed in a user interface via a display unit to indicate the marked position. In other words, the user can know the marked position through the displayed image index in the user interface.

Next, in step S320, a selection of the marked position corresponding to the vehicle is received. As mentioned above, in one embodiment, the marked position can be set as the license plate position of the vehicle. In another embodiment, a plurality of marked points may be provided and the user may select one of the aforementioned marked points to determine the marked position. It is noted that, in some embodiments, an image index corresponding to the marked position may be provided when capturing an image of the vehicle, and the image index corresponding to the marked position can be displayed in a user interface via a display unit to indicate the marked position. In other words, the user can know the marked position through the displayed image index in the user interface. It is noted that the selection of the above marked position can be entered in any form. For example, the selection of the marked position may be input to the electronic device through a sound receiving unit, a touch screen, a sensing unit, an infrared detecting unit, and/or a physical button on the electronic device. In one embodiment, the display unit may further include a touch screen and the image index corresponding to the marked position may be displayed in a user interface through the touch screen, and the user can input/enter the selection of the marked position by clicking the image index corresponding to the marked position on the touch screen.

After the selection of the marked position is received, in step S330, the first sensing data corresponding to the marked position is obtained via at least one sensor. It should be noted that a first absolute world coordinate of the image capture unit at this time can be calculated through the first sensing data. As described above, the sensor can detect the orientation of an electronic device and generate corresponding sensing data. In some embodiments, the sensor may be an accelerometer such as a G-sensor for generating information of velocity and displacement when the electronic device moves. In some embodiments, the sensor may be a Gyro sensor for generating information of angular acceleration when the electronic device moves. In some embodiments, the sensor may be a compass for detecting an angle between an electronic device and a geographical direction, such as direction of the North Pole or the South Pole. It is understood that, the above sensors are examples of the application, and the present invention is not limited thereto. Any sensor which can detect the orientation of an electronic device can be applied in the present invention. As described, the sensor can detect the orientation of the electronic device. It is noted that, in some embodiments, the orientation comprises angle information corresponding to the electronic device in reference to at least one reference point. In some embodiments, the orientation can be represented as an included angle between an axis which is vertical to at least one plane of the electronic device and a specific direction, such as the direction of gravity or the geographical direction. In some embodiments, the six-axis coordinates of the electronic device may be tracked according to a combination of an azimuth angle and an elevation angle of the electronic device detected by the sensor (e.g., a Gyro sensor) and a technique of visual inertial ranging, wherein the six-axis coordinate data indicates the world coordinates and rotation and displacements around the X, Y, and Z axis, respectively. The three axes of displacement determine the orientation and size of the electronic device. In other words, the absolute world coordinates of the electronic device at this time can be obtained by the corresponding sensing data generated by the sensor.

Next, in step S340, a first image corresponding to the vehicle is captured and a second sensing data is obtained via the at least one sensor. It is noted that a second absolute world coordinate of the image capture unit at which the first image corresponding to the vehicle is captured may be calculated through the second sensing data.

Thereafter, in step S350, an angle is calculated according to the marked position, the first sensing data, and the second sensing data, and then in step S360, a specific position of the vehicle corresponding to the first image is determined according to the marked position and the calculated angle. In some embodiments, the marked position can be served as the coordinate origin to form a specific axis with the first absolute world coordinate corresponding to the first sensing data, and then an angle θ can be calculated according to an included angle between the second absolute world coordinate corresponding to the second sensing data and the specific axis. In some embodiments, an image recognition is performed on the first image to obtain an identification image for the first image, and the specific position of the vehicle corresponding to the first image is determined according to the identification image and the angle θ.

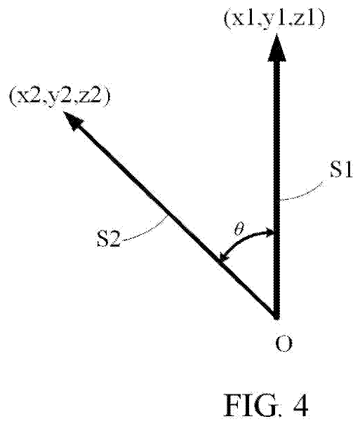

FIG. 4 is a schematic diagram illustrating an example of the angle calculation of the invention. As shown in FIG. 4, the coordinates (x0, y0, z0) of the marked position O are taken as the coordinate origin and the angle of 0 degree and a specific axis S1 is formed by using the marked position O and the first absolute world coordinates (x1, y1, z1) corresponding to the first sensing data. A line segment S2 can be obtained according to the second absolute world coordinate (x2, y2, z2) corresponding to the second sensing data and the marked position O. An angle θ can be calculated by the included angle between the specific axis S1 and the line segment S2 to determine one of a plurality of vehicle positions depending on the angle θ. It should be noted that in some embodiments, the angle θ may be calculated in a counterclockwise direction along the specific axis S1, and the angle is ranged from 0 to 359 degrees. In another embodiment, the angle θ can be calculated in a clockwise direction along the specific axis S1, and the angle is ranged from 0 to 359 degrees.

In some embodiments, a plurality of vehicle positions corresponding to the marked position may be provided, wherein each vehicle position has a corresponding relation with one of angular intervals, and one of the angular intervals can be determined according to the calculated angle and one of the vehicle positions is determined as the specific position according to the determined angle interval.

In some embodiments, a partial image corresponding to the selected marked position may be captured, and an image recognition is performed on the partial image to obtain an identification image corresponding to the partial image, determine one of mapping relations according to the identification image, and determine the specific position of the vehicle corresponding to the first image according to the determined mapping relation and the angle. Each of the mapping relations includes a plurality of vehicle positions and a plurality of angular intervals and each of the vehicle positions corresponds to one of the angular intervals.

It is noted that, in some embodiments, a specific table can be used to record the mapping relations between the angular intervals corresponding to a marked position O and the corresponding vehicle positions, wherein the marked position O is set to be an angle of 0 degree. Table 1 shows an example of the mapping table.

TABLE 1

| Angular Interval (degree) | Vehicle Position |
|---|---|
| 1~90 | P1 |
| 91~105 | P2 |
| 106~120 | P3 |
| 121~135 | P4 |
| 136~150 | P5 |
| 151~165 | P6 |
| 166~180 | P7 |
| 181~195 | P8 |
| 196~210 | P9 |
| 211~225 | P10 |
| 226~240 | P11 |
| 241~255 | P12 |
| 256~270 | P13 |
| 271~359 | P14 |

As shown in table 1, when the angle θ corresponding to the first image is calculated, the table 1 can be looked up according to the angle θ to identify the corresponding vehicle position. In the example, the determined vehicle position is P1 when the angle is between 0˜90 degrees, the determined vehicle position is P2 when the angle is between 91˜105 degrees, the determined vehicle position is P3 when the angle is between 106˜120 degrees, the determined vehicle position is P4 when the angle is between 121˜135 degrees, the determined vehicle position is P5 when the angle is between 136˜150 degrees, the determined vehicle position is P6 when the angle is between 151˜165 degrees, the determined vehicle position is P7 when the angle is between 166˜180 degrees, the determined vehicle position is P8 when the angle is between 181˜195 degrees, the determined vehicle position is P9 when the angle is between 196˜210 degrees, the determined vehicle position is P10 when the angle is between 211˜225 degrees, the determined vehicle position is P11 when the angle is between 226˜240 degrees, the determined vehicle position is P12 when the angle is between 241˜255 degrees, the determined vehicle position is P13 when the angle is between 256˜270 degrees, and the determined vehicle position is P14 when the angle is between 271˜359 degrees. For example, when the marked position O is the front license plate of the vehicle, wherein the vehicle position P3 may represent the right front wheel, the vehicle position P5 may represent the right rear wheel, the vehicle position P10 may represent the left rear wheel, and the vehicle position P12 may represent the left front wheel. It is noted that, the above table is an example of the application, and the present invention is not limited thereto. By using the angle θ, when the first image is a wheel image, it can further be determined which wheel of the vehicle the first image belongs to when the recognition result shows that it is a wheel image. It is understood that, the mapping relations between the angular intervals corresponding to a marked position and the corresponding vehicle position in table 1 can be obtained by training in advance. It is noted that, in some embodiments, a plurality of tables for different marked positions may be trained in advance, in which each table records the mapping relations between the angular intervals corresponding to one of the marked positions and the corresponding vehicle positions, and then may be looked up according to a specific marked position to identify the corresponding mapping relation between the angular intervals corresponding to the specific marked position and the corresponding vehicle positions, so that one of the angle intervals is determined according to the calculated angle, and one of the vehicle positions is determined as the specific position according to the determined angle interval.

In some embodiments, data containing the calculated angle is encrypted to generate an encrypted data using first data, a second image is generated according to the encrypted data and the first image, and the second image is stored to a storage unit or the second image is transmitted to a network server via a network. In some embodiments, the second image and the first data can be obtained and the second image is decrypted with the first data to obtain the calculated angle and the first image.

In some embodiments, a partial image corresponding to the selected marked position can be obtained, an image recognition is performed on the partial image to obtain an identification image corresponding to the partial image, and one of mapping relations is determined according to the identification image, and the specific position of the vehicle corresponding to the first image is determined according to the determined mapping relation and the calculated angle, wherein each of the mapping relations includes a plurality of vehicle positions and a plurality of angular intervals and each of the vehicle positions corresponds to one of the angular intervals.

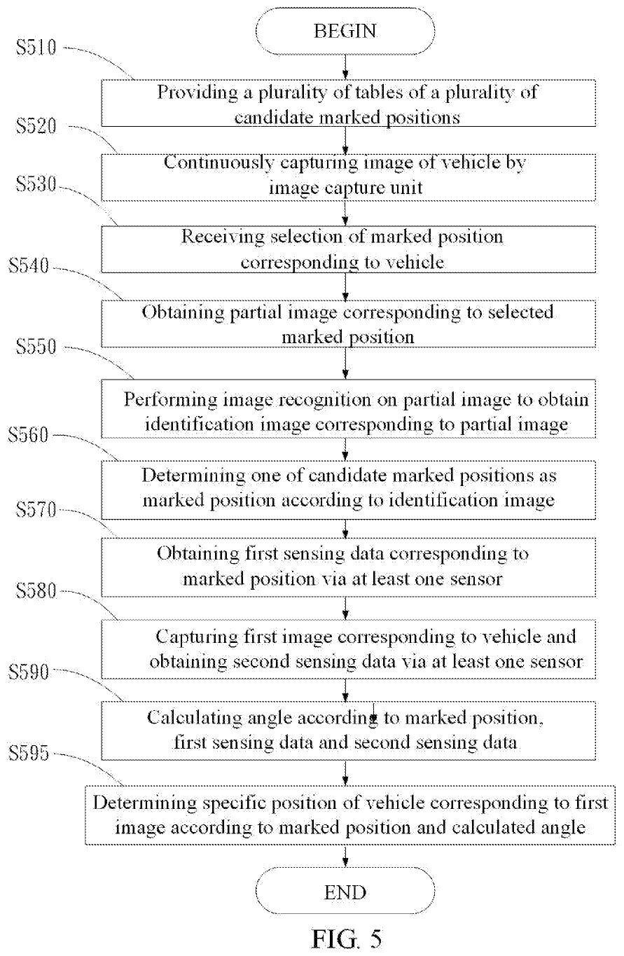

FIG. 5 is a flowchart of another embodiment of a position determination method for vehicle of the invention. The position determination method for vehicle of the invention can be used in an electronic device, such as a mobile phone, a smart phone, a PDA, a GPS, a notebook, a tablet computer, a wearable device, or other portable devices.

First, in step S510, multiple tables of multiple candidate marked positions are provided, wherein each table records a mapping relation of one of the candidate marked positions and each mapping relation includes multiple vehicle positions and multiple angle intervals and each vehicle position corresponds to one of the angular intervals. In some embodiments, a plurality of tables for different marked positions may be obtained by training in advance, in which each table records the mapping relations between the angular intervals corresponding to one of the marked positions and the corresponding vehicle positions, and then these tables may be looked up according to a specific marked position to identify the corresponding mapping relation between the angular intervals corresponding to the specific marked position and the corresponding vehicle positions.

Thereafter, in step S520, images of a vehicle are continuously captured by an image capture unit. An image of the vehicle may be an image of a part or all of a vehicle such as a car. The user of the electronic device can turn on the image capturing function to continuously capture any part of the vehicle through the image capture unit to generate the images of the vehicle. For example, the image of the vehicle may include a partial image including a designated marked position or a partial image of the vehicle such as an image containing the wheel part of the vehicle. It is understood that, the above images of the vehicle are examples of the application, and the present invention is not limited thereto. In an embodiment, the marked position can be set as the license plate position of the vehicle. In another embodiment, a plurality of marked points may be provided and the user may select one of the aforementioned marked points to determine the marked position. It is noted that, in some embodiments, an image index corresponding to the marked position may be provided when capturing an image of the vehicle, and the image index corresponding to the marked position can be displayed in a user interface via a display unit to indicate the marked position. In other words, the user can know the marked position through the displayed image index in the user interface.

Next, in step S530, a selection of a marked position corresponding to the vehicle is received. As mentioned above, in one embodiment, the marked position can be set as the license plate position of the vehicle. In another embodiment, a plurality of marked points may be provided and the user may select one of the aforementioned marked points to determine the marked position. It is noted that, in some embodiments, an image index corresponding to the marked position may be provided when capturing an image of the vehicle, and the image index corresponding to the marked position can be displayed in a user interface via a display unit to indicate the marked position. In other words, the user can know the marked position through the displayed image index in the user interface. It is noted that the selection of the above marked position can be entered in any form. For example, the selection of the marked position may be input to the electronic device through a sound receiving unit, a touch screen, a sensing unit, an infrared detecting unit, and/or a physical button on the electronic device. In one embodiment, the display unit may further include a touch screen and the image index corresponding to the marked position may be displayed in a user interface through the touch screen, and the user can input/enter the selection of the marked position by clicking the image index corresponding to the marked position on the touch screen.

After the selection of the marked position is received, in step S540, a partial image corresponding to the selected marked position is obtained, and in step S550, an image recognition is performed on the partial image to obtain an identification image corresponding to the partial image. In some embodiments, a number of image recognition technologies, such as deep learning, feature classification and recognition and so on, can be used to obtain the identification image corresponding to the partial image. For example, the identification image can be a license plate image, but the invention is not limited thereto.

When the identification image of the partial image is obtained, in step S560, one of the candidate marked positions is determined as the marked position according to the identification image. One of the plurality of tables can be determined by the determined candidate marked position, and then the mapping relation between the vehicle position and the corresponding angle interval can be obtained from the determined table.

In step S570, the first sensing data corresponding to the marked position is obtained via at least one sensor. It should be noted that a first absolute world coordinate of the image capture unit at this time can be calculated through the first sensing data. As described above, the sensor can detect the orientation of an electronic device and generate corresponding sensing data. In some embodiments, the sensor may be an accelerometer such as a G-sensor for generating information of velocity and displacement when the electronic device moves. In some embodiments, the sensor may be a Gyro sensor for generating information of angular acceleration when the electronic device moves. In some embodiments, the sensor may be a compass for detecting an angle between an electronic device and a geographical direction, such as direction of the North Pole or the South Pole. It is understood that, the above sensors are examples of the application, and the present invention is not limited thereto. Any sensor which can detect the orientation of an electronic device can be applied in the present invention. As described, the sensor can detect the orientation of the electronic device. It is noted that, in some embodiments, the orientation comprises angle information corresponding to the electronic device in reference to at least one reference point. In some embodiments, the orientation can be represented as an included angle between an axis which is vertical to at least one plane of the electronic device and a specific direction, such as the direction of gravity or the geographical direction.

Next, in step S580, a first image corresponding to the vehicle is captured and a second sensing data is obtained via the at least one sensor. It is noted that a second absolute world coordinate of the image capture unit at which the first image corresponding to the vehicle is captured may be calculated through the second sensing data.

Thereafter, in step S590, an angle is calculated according to the marked position, the first sensing data, and the second sensing data, and then in step S595, a specific position of the vehicle corresponding to the first image is determined according to the marked position and the calculated angle. In some embodiments, the marked position can be served as the coordinate origin to form a specific axis with the first absolute world coordinate corresponding to the first sensing data, and then an angle θ can be calculated according to an included angle between the second absolute world coordinate corresponding to the second sensing data and the specific axis. In some embodiments, an image recognition is performed on the first image to obtain an identification image for the first image, and the specific position of the vehicle corresponding to the first image is then determined according to the identification image and the angle θ. In some embodiments, data containing the calculated angle is encrypted to generate an encrypted data using first data, a second image is generated according to the encrypted data and the first image, and the second image is stored to a storage unit or the second image is transmitted to a network server via a network. In some embodiments, the second image and the first data can be obtained and the second image is decrypted with the first data to obtain the calculated angle and the first image.

When the angle θ corresponding to the first image is calculated, a mapping table can be looked up according to the angle θ to identify the corresponding vehicle position. Taking Table 1 as an example, the determined vehicle position is P1 when the angle is between 0˜90 degrees, the determined vehicle position is P2 when the angle is between 91˜105 degrees, the determined vehicle position is P3 when the angle is between 106˜120 degrees, the determined vehicle position is P4 when the angle is between 121˜135 degrees, the determined vehicle position is P5 when the angle is between 136˜150 degrees, the determined vehicle position is P6 when the angle is between 151˜165 degrees, the determined vehicle position is P7 when the angle is between 166˜180 degrees, the determined vehicle position is P8 when the angle is between 181˜195 degrees, the determined vehicle position is P9 when the angle is between 196˜210 degrees, the determined vehicle position is P10 when the angle is between 211˜225 degrees, the determined vehicle position is P11 when the angle is between 226˜240 degrees, the determined vehicle position is P12 when the angle is between 241˜255 degrees, the determined vehicle position is P13 when the angle is between 256˜270 degrees, and the determined vehicle position is P14 when the angle is between 271˜359 degrees. For example, when the marked position O is the front license plate of the vehicle, the vehicle position P3 may represent the right front wheel, the vehicle position P5 may represent the right rear wheel, the vehicle position P10 may represent the left rear wheel, and the vehicle position P12 may represent the left front wheel. It is noted that, the above table is an example of the application, and the present invention is not limited thereto. By using the angle θ, when the first image is a wheel image, it can further be determined which wheel of the vehicle the first image belongs to when the recognition result shows that it is a wheel image.

Therefore, the position determination methods and systems for vehicle of the present invention can determine the position of the vehicle corresponding to a specific image according to the marked position in the image of the vehicle captured by the image capture unit of the electronic device and relative coordinate position corresponding to the sensing data detected by the sensor, thereby increasing the accuracy of the relevant vehicle application, identification and determination.

Position determination methods for vehicle may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A position determination method for vehicle applied to an electronic device, comprising:
continuously capturing images of a vehicle by an image capture unit;
receiving a selection of a marked position corresponding to the vehicle;
obtaining first sensing data corresponding to the marked position via at least one sensor;
capturing a first image corresponding to the vehicle and obtaining second sensing data via the at least one sensor;
calculating an angle according to the marked position, the first sensing data, and the second sensing data; and
determining a specific position of the vehicle corresponding to the first image according to the marked position and the calculated angle.

2. The method of claim 1, further comprising:
providing a plurality of vehicle positions corresponding to the marked position, wherein each of the vehicle positions has a mapping relation corresponding to one of a plurality of angular intervals; and
determining one of the angular intervals according to the determined angle, and determining one of the vehicle positions as the specific position according to the determined angular interval.

3. The method of claim 1, further comprising providing an image index corresponding to the marked position and displaying the image index corresponding to the marked position in a user interface via a display unit.

4. The method of claim 1, further comprising:
obtaining a partial image corresponding to the selected marked position;
performing an image recognition on the partial image to obtain an identification image corresponding to the partial image; and
determining one of mapping relations according to the identification image, the first image according to the determined mapping relation and the determined angle,
wherein each of the mapping relations includes a plurality of vehicle positions and a plurality of angular intervals and each of the vehicle positions corresponds to one of the angular intervals.

5. The method of claim 1, further comprising:
encrypting data containing the determined angle to generate an encrypted data using first data;
generating a second image according to the encrypted data and the first image; and
storing the second image to a storage unit or transmitting the second image to a network server via a network.

6. The method of claim 1, further comprising:
obtaining the second image and the first data; and
decrypting the second image with the first data to obtain the determined angle and the first image.

7. The method of claim 1, wherein the at least one sensor comprises a compass, an accelerometer, or a Gyro sensor.

8. The method of claim 1, wherein the marked position is a license plate of the vehicle.

9. A position determination method for vehicle for use in an electronic device, comprising:
at least one sensor configured to detect a orientation of the electronic device to generate corresponding sensing data;
an image capture unit configured to continuously capture images of a vehicle; and
a processing unit coupled to the at least one sensor and the image capture unit for receiving a selection of a marked position corresponding to the vehicle, obtaining first sensing data corresponding to the marked position via the at least one sensor, capturing a first image corresponding to the vehicle via the image capture unit and obtaining second sensing data via the at least one sensor, calculating an angle according to the marked position, the first sensing data, and the second sensing data, and determining a specific position of the vehicle corresponding to the first image according to the marked position and the calculated angle.

10. A machine-readable storage medium comprising a computer program, which, when executed, causes a device to perform a position determination method for vehicle applied to an electronic device, wherein the method comprises:
continuously capturing images of a vehicle by an image capture unit;
receiving a selection of a marked position corresponding to the vehicle;
obtaining first sensing data corresponding to the marked position via at least one sensor;
capturing a first image corresponding to the vehicle and obtaining second sensing data via the at least one sensor;
calculating an angle according to the marked position, the first sensing data, and the second sensing data; and
determining a specific position of the vehicle corresponding to the first image according to the marked position and the calculated angle.
